(19) United States
(12) Patent Application Publication
(10) Pub. No.: US 2009/0002165 A1
(43) Pub. Date: Jan. 1, 2009

(54) METHOD AND SYSTEM OF DETERMINING A LOCATION CHARACTERISTIC OF A RFID TAG

(75) Inventor: John R Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: MICRON TECHNOLOGY, INC., BOISE, ID (US)

(21) Appl. No.: 11/769,953

(22) Filed: Jun. 28, 2007

(51) Int. Cl. G08B 13/14

(52) U.S. Cl. 340/572.1

(57) ABSTRACT

Method and system of determining a locational characteristic of a RFID tag. At least some of the illustrative embodiments are systems comprising a radio frequency identification (RFID) reader, and a phased-array reading antenna coupled to the RFID reader (the phased-array reading antenna comprising a plurality of antenna elements). The system is configured to determine a value indicative of direction of a RFID tag relative to the phased-array reading antenna based on an analysis of phase of signals induced on each of the antenna elements of the phased-array antenna by a return signal from the RFID tag.

### BACKGROUND

1. Field

At least some of the various embodiments are directed to determining location of radio frequency identification (RFID) tags relative to a RFID reader.

2. Description of the Related Art

Radio frequency identification (RFID) technology is used to identify goods in wholesale and retail distribution. For example, in a wholesale distribution warehouse, each pallet may have a RFID tag that identifies the pallet and/or the goods on the pallet. Likewise, in a retail setting, the RFID tag on an item may be read to identify the item at a checkout stand. In some cases, determining the presence and identity of an item bearing a RFID tag is sufficient. However, in other cases, determining the presence, identity and location of the item is desirable.

### BRIEF DESCRIPTION OF THE DRAWINGS

For a detailed description of various embodiments, reference will now be made to the accompanying drawings in which:

FIG. 1 shows a radio frequency identification (RFID) system in accordance with at least some embodiments;

FIG. 2 shows a system in accordance with at least some embodiments;

FIG. 3 shows a set of illustrative signals induced on antenna elements of a phased-array antenna;

FIG. 4 shows a block diagram of a system to analyze phase for a direction determination in accordance with various embodiments;

FIGS. 5A, 5B and 5C show various delayed version of the signals of FIG. 3, along with respective combined signals;

FIG. 6 shows a phased-array antenna comprising a plurality of patch antennas in accordance with at least some embodiments;

FIG. 7 shows a far-field radiation/reception pattern of an antenna element of a phased-array antenna in accordance with at least some embodiments;

FIG. 8 shows a phased-array antenna comprising a plurality of Yagi-Uda antennas in accordance with at least some embodiments; and

FIG. 9 shows a method in accordance with at least some embodiments.

### NOTATION AND NOMENCLATURE

Certain terms are used throughout the following description and claims to refer to particular system components. As one skilled in the art will appreciate, design and manufacturing companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . . ”

Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system,” “subsystems” within the system, a radio frequency identification (RFID) tag, a RFID reader, or any other device comprising one or more components.

### DETAILED DESCRIPTION OF DISCLOSED EMBODIMENTS

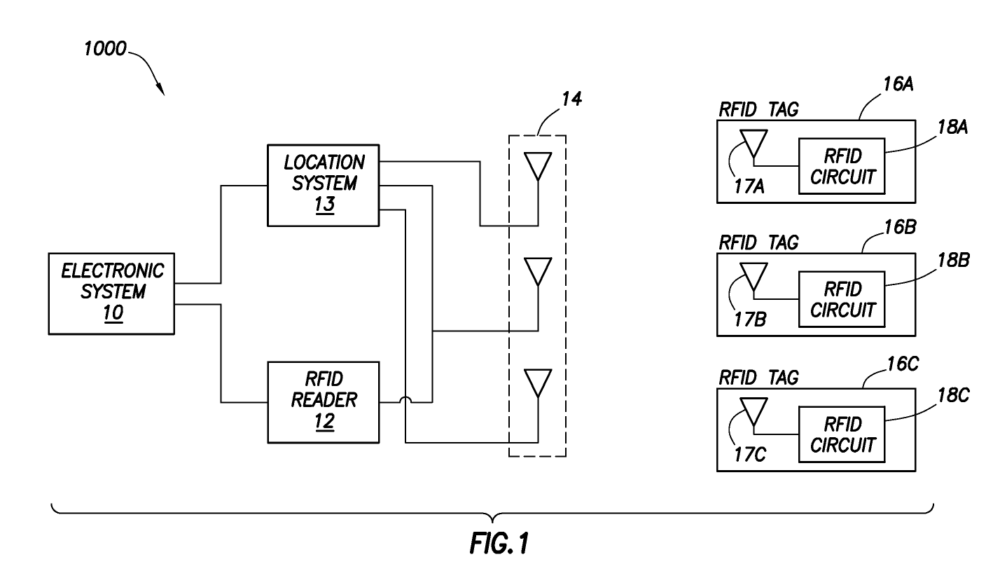

FIG. 1 illustrates a system 1000 in accordance with at least some embodiments. In particular, system 1000 comprises an electronic system 10 (e.g., a computer system) coupled to a radio frequency identification (RFID) reader 12 and a location system 13. The RFID reader 12 may be equivalently referred as an interrogator. By way of at least one element of phased-array antenna 14, the RFID reader 12 communicates with one or more RFID tags 16A-16C proximate to the RFID reader (i.e., within communication range).

Considering a single RFID tag 16A (but the description equally applicable to all the RFID tags 16), the communication sent by the RFID reader 12 is received by tag antenna 17A, and passed to the RFID circuit 18A. If the communication from the RFID reader triggers a response, the RFID circuit 18 sends to the RFID reader 12 the response (e.g., a tag identification value, or data held in the tag memory) using the tag antenna 17A. The RFID reader 12 passes data obtained from the various RFID tags 16 to the electronic system 10.

Simultaneously with the RFID reader 12 obtaining a response from RFID tag 16A, the location system 13 determines a locational characteristic (e.g., value indicative of direction to the RFID tag 16A relative to the phased-array antenna 14 and/or a value indicative of distance to the RFID tag 16A (discussed more below)). The location system 13 passes the direction value, and in some cases distance value, of the RFID tag 16A to the electronic system 10. In other embodiments, the functionality of the RFID reader 12 and location system 13 may be combined in a single device or system. Further, while the RFID reader 12 is shown as electrically coupled to only one antenna element being in the center of the phased-array antenna 14, in other embodiments the RFID circuit 12 may couple to any other antenna element.

The electronic system 10 receives data from the RFID reader 12 and/or location system 13, and performs any suitable function. For example, the electronic system 10, based on the data received, may log and/or control ingress and egress to a building or parking garage, note the location of an employee in a work location, direct a parcel identified by the RFID tag 16 down a particular conveyor system, or inventory products in a shopping cart for purposes of checkout and payment.

There are several types of RFID tags operable in the illustrative system 1000. For example, RFID tags may be active tags, meaning each RFID tag comprises its own internal battery or other power source. Using power from the internal power source, an active RFID tag monitors for signals from the RFID reader 12. When an interrogating signal directed to the RFID tag is sensed, the tag response may be tag-radiated radio frequency (RF) power (with a carrier modulated to represent the data or identification value) using power from the internal battery or power source.

A semi-active tag may likewise have its own internal battery or power source, but a semi-active tag remains dormant (i.e., powered-off or in a low power state) most of the time. When an antenna of a semi-active tag receives an interrogating signal, the power received is used to wake or activate the semi-active tag, and a response (if any) comprising an identification value is sent by modulating the RF backscatter from the tag antenna, with the semi-active tag using power for internal operations from its internal battery or power source. In particular, the RFID reader 12 continues to transmit power after the RFID tag is awake. While the RFID reader 12 transmits, the tag antenna 17 of the RFID tag 16 is selectively tuned and de-tuned with respect to the carrier frequency. When tuned, significant incident power is absorbed by the tag antenna 17. When de-tuned, significant power is reflected by the tag antenna 17 to the antenna 14 of the RFID reader 12. The data or identification value modulates the carrier to form the reflected or backscattered electromagnetic wave. The RFID reader 12 reads the data or identification value from the backscattered electromagnetic waves. Thus, in this specification and in the claims, the terms “transmitting” and “transmission” include not only sending from an antenna using internally sourced power, but also sending in the form of backscattered signals.

A third type of RFID tag is a passive tag, which, unlike active and semi-active RFID tags, has no internal battery or power source. The tag antenna 17 of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of RF backscatter.

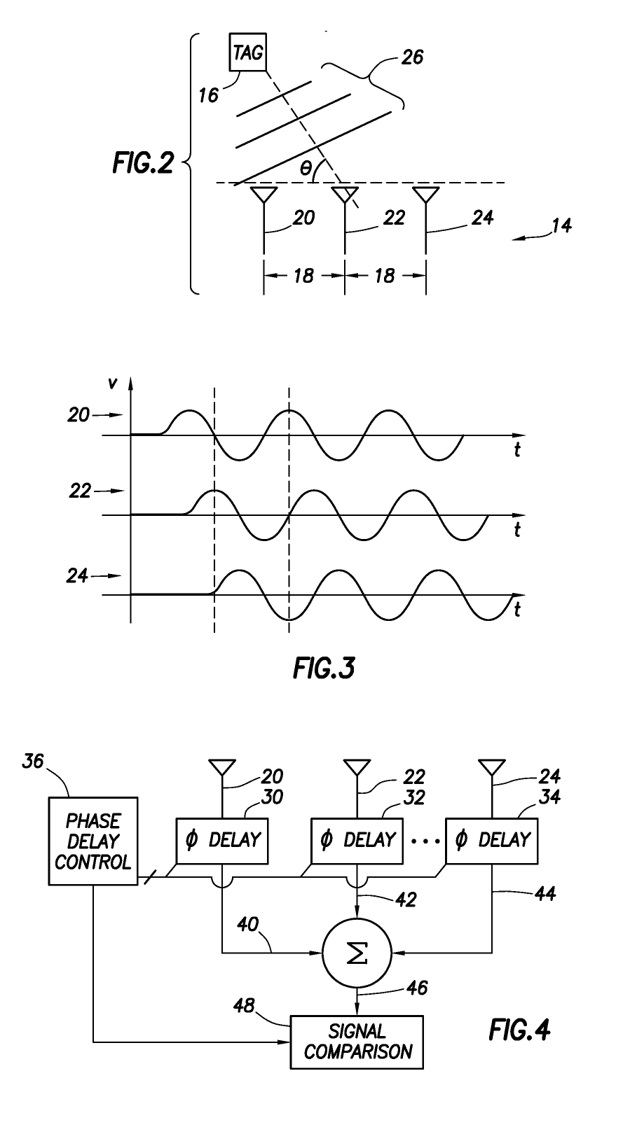

As mentioned above, the location system 13 determines the direction of RFID tags relative to the phased-array antenna 14. In accordance with the various embodiments, determining direction of a RFID tag involves an analysis of phase of signals induced on each antenna element of the phased-array antenna 14. Consider for purposes of explanation the system of FIG. 2. In particular, a RFID tag 16 is located at an angle θ relative to a center point of a one-dimensional phased-array antenna 14. The RFID tag 16 transmits a series of electromagnetic waves 26 (either as backscatter, or using power from an internal power source).

FIG. 3 illustrates signals induced on each of the three illustrative antenna elements 20, 22 and 24 of phased-array antenna 14. The frequency of the signals induced on each of the antenna elements is the same, and in the illustration of FIG. 3 the amplitudes are approximately the same. To the extent the amplitudes differ, the antenna elements most distant from the RFID tag 16 will have smaller amplitude (i.e. antenna element 24) than the antenna elements closest to the RFID tag 16 (i.e., antenna element 20). While the signals induced on each antenna element are the same frequency and approximately the same amplitude, the phase of the signals varies. One factor that affects phase difference is the spacing 18 between the antenna elements. However, in accordance with the various embodiments, the spacing 18 is held constant and is limited to less than or equal to the wavelength of the signals to be received. In the case of RFID system operating at approximately 900 mega-Hertz, the spacing is less than or equal to 0.33 meters.

Another factor that affects the phase difference of the signals induced on the antenna elements is the angle θ of the RFID tag relative to the phased-array antenna. The smaller the angle θ, the greater the difference in phase between the signals. Likewise, as the angle θ approaches 90 degrees, these differences in the signals becomes smaller. For the illustrative case of FIG. 2 with the RFID tag 16 being left-of-center, the phase of the signal associated with antenna element 20 leads the phase of the signal associated with antenna element 22. Assuming equally spaced antenna elements, the phase of the signal associated with antenna element 20 leads the phase of the signal associated with antenna element 24 by an integer multiple of the phase lead relative to the signal associated with antenna element 22. Given that the signals received on the antenna elements are periodic, for the illustrative case of FIG. 2, it is equally correct to say that the phase of the signal associated with antenna element 20 lags the phase of antenna elements 22 and 24, with the amount by which the signal is said to lag being greater than the amount by which the signal is said to lead.

In accordance with various embodiments, in order to determine the angle θ of the RFID tag relative to the phased-array antenna 14, an analysis of the phase of the signals induced on each antenna element is performed. FIG. 4 is a block diagram that conceptually illustrates analyzing phase to determine direction of the RFID tag for the illustrative systems of FIGS. 1 and 2 having a phased-array antenna with an illustrative tree antenna elements. The system of FIG. 4 may be implemented using discrete electrical components, the functionality could be implemented in software (e.g., a digital signal processor), or a combination of hardware and software. The signal induced on each of the three illustrative antenna element 20, 22 and 24 is fed to respective phase (φ) delay systems 30, 32 and 34. Each phase delay system selectively delays the signal from its respective antenna element by an amount controlled by the phase delay control system 36 to produce respective delayed signals 40, 42 and 44. The delayed signals 40, 42 and 44 are then combined (e.g., summed) to produce a combined signal that is forwarded to a signal comparison system 48. Characteristics of the combined signals for varying applied delays are compared by the signal comparison system 48 to determine value indicative of direction of the RFID tag.

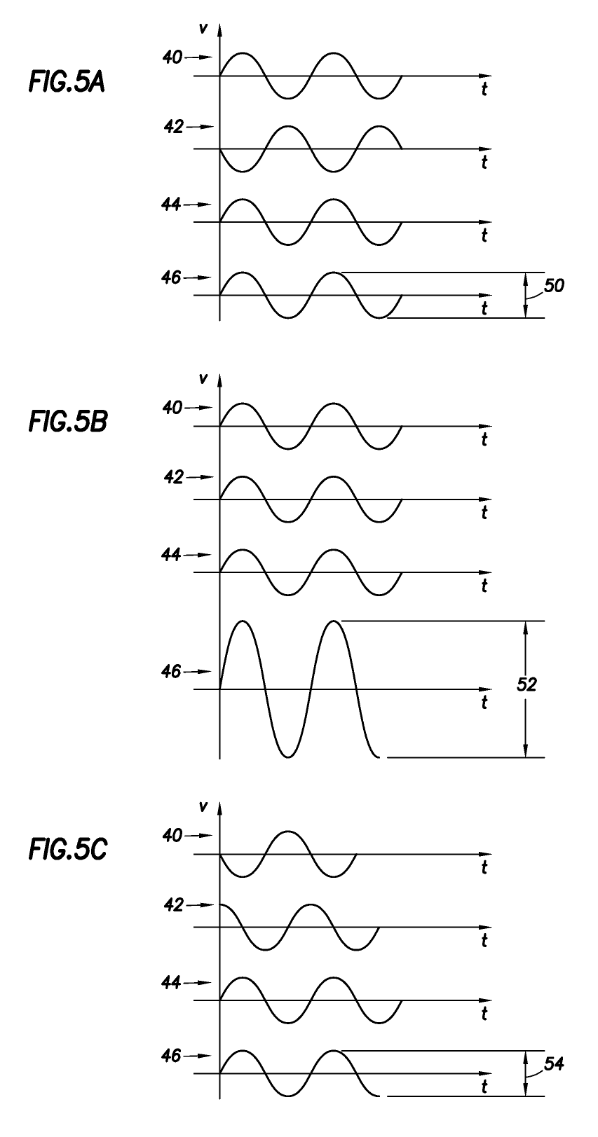

Consider, for purposes of explanation, the illustrative system of FIG. 2 and the illustrative signals of each antenna element of FIG. 3. In order to determine the direction of the RFID tag, the phase delay control system 36 applies a plurality of phase delay values. In some embodiments (and as used in the example below), a limited range of phase delay values are used (e.g., π radians or less) along with an assumed orientation; however, given the signals are periodic, and the spacing of less than a wavelength, phase delay values alone (i.e., without a left-of-center or right-of-center assumption) may be used if the phase delay values are not constrained to be less than or equal to π radians. In a first example iteration, the phase delay control system 36 may assume a first particular phase delay value φ and orientation (e.g., right-of-center). With the assumptions of the first example iteration, the phase delay control system 36 may direct the phase delay systems 30, 32 and 34 to apply zero radians, φ radians and 2φ radians of delay respectively. FIG. 5A illustrates the (steady state) delayed signals created by this first example iteration, as well as the combined signal 46. As shown, the combined signal 46 has a peak-to-peak amplitude 50 of an illustrative one unit voltage. In a second example iteration, the phase delay control system 36 may again assume the particular phase delay value φ, but with a different orientation (e.g., left-of-center). With the assumptions of the second example iteration, the phase delay control system 36 may direct the phase delay systems 30, 32 and 34 to apply 2φ radians, φ radians and zero radians of delay respectively. FIG. 5B illustrates the (steady state) delayed signals created by this second example iteration, as well as the combined signal 46. As shown, the combined signal 46 has a peak-to-peak amplitude 52 of an illustrative three unit voltage. In a third example iteration the phase delay control system 36 may assume a second particular phase delay value of zero (corresponding to angle θ being a right angle). With the assumptions of the third example iteration, the phase delay control system 36 may direct each of the phase delay systems 30, 32 and 34 to apply zero radians of delay. FIG. 5C illustrates the (steady state) delayed signals created by this third example iteration, as well as the combined signal 46. As shown, the combined signal 46 has a peak-to-peak amplitude 54 of an illustrative one unit voltage.

Thus, for a plurality of phase delay values (and in some cases assumed orientations), the delayed signals are created and respective combined signals generated. The signal comparison system 48 compares the combined signals to determine which of the plurality of tested phase delay values (and possibly orientations) corresponds to the actual direction of the RFID tag. In some embodiments, the determination is based on which phase delay value creates the combined signal with the largest or maximum peak-to-peak voltage. In the illustrations of FIGS. 5A, 5B and 5C, the phase delay value φ and left-of-center assumption FIG. 5B) produced the combined signal with the largest peak-to-peak amplitude. In other embodiments, the determination is based on which phase delay value creates the combined signal with the smallest or minimum pea-to-peak voltage.

Once the phase delay value indicative of direction is determined (e.g., the phase delay value producing the largest peak-to-peak combined signal), the actual direction of the RFID tag relative to the phased-array antenna may be determined by way of a look-up table. In particular, for a given antenna element spacing and each angle θ, the system designer may calculate a table that relates phase delay value to direction of the RFID tag relative to the phased-array antenna. The table below illustrates a lookup table for a one-dimensional phased-array antenna, and in accordance with at least some embodiments.

TABLE 1

| Selected Phase | Direction of |
|---|---|
| Delay Value | RFID tag |
| LOC φ₁ | LOC θ₁ |
| LOC φ₂ | LOC θ₂ |
| LOC φ₃ | LOC θ₃ |
| Zero | Zero |
| ROC φ₁ | ROC θ₁ |
| ROC φ₂ | ROC θ₂ |
| ROC φ₃ | ROC θ₃ |

Thus, once the phase delay value that corresponds to the direction is determined (e.g., left-of-center (LOC)_{φ2}, or right-of-center (ROC)_{φ3}), the actual direction of the RFID tag relative to the phased-array antenna may be determined by reference to a lookup table similar to that of Table 1.

The parameters of the system underlying the discussion to this point were selected so as not to unduly complicate the description of the analysis of the phase of the signals associated with each antenna element and corresponding determination of the direction of the RFID tag. In particular, the phased-array antenna 14 is shown to be one-dimensional and having only three antenna elements; however, in other embodiments the phased-array antenna is one dimensional but comprises more than three antenna elements. In such embodiments, each antenna element will have a corresponding phase delay system (whether in hardware or software), and the phase delay applied across may be an integer multiple of the tested phase delay value. In generic form then, for a particular tested phase delay value φ each phase delay system may apply delays for testing left-of-center of [nφ radians, (n−1) φ radians, (n−2) φ radians, . . . φ radians, 0 radians] where n is the number of antenna elements. Likewise, for the particular tested phase delay value φ, each phase delay system may apply a delay for testing right-of-center of [0 radians, φ radians, . . . (n−2) φ radians, (n−1) φ radians, φ radians], again where n is the number of antenna elements. Moreover, multiple phase delay values may be tested corresponding to both left-of-center and right-of-center.

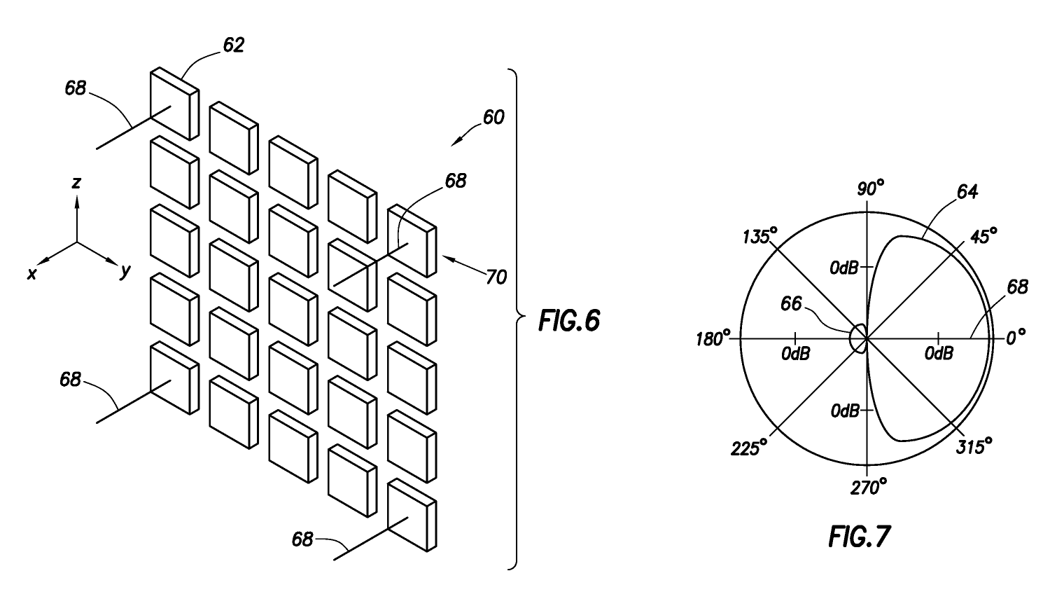

In yet still further embodiments, rather than one dimensional, the phased-array antenna may be two dimensional. FIG. 6 illustrates a two dimensional phased-array antenna 60 in accordance with some embodiments. In particular, the phased-array antenna 60 comprises a plurality of antenna elements 62. In the embodiments illustrated in FIG. 6, each antenna element 62 is an individual patch antenna; however, other types of antenna elements may be equivalently used (e.g., dipole, Yagi-Uda, circular). Each illustrative patch antenna comprises an active or driven element separated from a ground plane, and in some cases the separation is by way of a dielectric material sandwiched between the active element and the ground plane. FIG. 7 illustrates a far-field radiation or reception pattern for a single illustrative patch antenna. Like most antennas, patch antennas have a far-field reception and/or radiation pattern than comprises a main lobe 64 extending from the same side of the patch antenna as the active element, and in some cases one or more secondary lobes 66 (in the illustrative case of patch antennas the secondary lobe extends from the same side as the ground plane, but for other antenna types the secondary lobes may abut the main lobe). The far-field radiation pattern main lobe 64 comprises a centroid axis 68 (lying along the 0 degree direction in the far-field radiation pattern of FIG. 7).

Retuning to FIG. 6, each antenna element 62 (e.g., a patch antenna) thus has a far-field radiation pattern main lobe and corresponding axis 68. So as not to unduly complication FIG. 6, the centroid axes of only the corner antenna elements 62 are illustrated. Thus, for the illustrative phase-array antenna 60 of FIG. 6, the axes of the antenna elements 62 are parallel. In the case of a one dimensional phased array antenna (e.g., the comprising only a single row 70 of antenna elements), the centroid axes may be not only parallel, but also coplanar.

Analyzing phase of the signals associated with each antenna element in systems using a two dimensional phased-array antenna (e.g., phase-array antenna 60) enables a determination of direction of the RFID tag in three dimensions. The signals associated with antenna elements 62 in each row of the phase-array antenna 60 may be analyzed to determine a direction of the RFID tag in the X-Y plane. For example, for a row 70 of antenna elements, by determining a phase delay value where a combined signal has a particular characteristic (FIG. 4), and correlating the phase delay value to a angle by way of a lookup table, a direction in the X-Y plane may be determined. The signals associated with antenna elements 62 in each column of the phase-array antenna 60 may be analyzed to determine a direction of the RFID tag in the X-Z plane. For example, for a column of antenna elements, by determining a phase delay value where a combined signal has a particular characteristic (FIG. 4), and correlating the phase delay value to a angle by way of a lookup table, a direction in the X-Z plane may be determined.

The various embodiments described to this point have assumed a phase-array antenna where the centroid axes of each antenna element are parallel; however, having parallel centroid axes for the phased-array antenna is not required. FIG. 8 illustrates systems in accordance with other embodiments where the centroid axes of the antenna elements are non-parallel. In particular, FIG. 8 illustrates a phased-array antenna 72 comprising a plurality of antenna elements 74 being illustrative Yagi-Uda antennas. The antenna elements 74 each have a centroid axis of the main lobe of the far-field radiation/reception pattern (the lobes not shown, but the centroid axes illustrated by dashed lines 76), and in the illustrative embodiments the centroid axes are non-parallel. Making the centroid axes of the antenna elements non-parallel may enable operational changes such as increasing the width of the field in which direction determinations are made (in the case of the centroid axes intersecting behind the phased-array antenna as would be the case in FIG. 8) or limiting the breadth of the field, possible making the direction determination more accurate (in the case of the centroid axes intersecting in front the phased-array antenna).

The discussion to this point has been limited to determination of direction of a RFID tag relative to a phased-array antenna. In some situations, direction alone may be sufficient information. In other embodiments, however, the user of the system may also like to know a distance of the RFID tag from the phased-array antenna. In accordance with at least some embodiments, a distance is determined based on the signal strength of the signal from the RFID tag.

In active RFID tags, once queried or otherwise armed by the RFID reader 12, the RFID tag broadcasts an electromagnetic signal using power from a battery internal to the RFID tag. The electromagnetic signal is received by the phased-array antenna. When the active RFID tag is very close to the antenna, the signal strength of the electromagnetic signal is high. Conversely, when the active RFID tag is far from the reading antenna 18 (e.g., at a far edge of an operational zone), the signal strength of the electromagnetic signal will be relatively low, and yet the RFID reader may still be able to extract a message and a corresponding value of interest. In accordance with at least some embodiments, the RFID reader 12, in addition to extracting the message from the electromagnetic signal, also generates and/or calculates a parameter indicative of the signal strength of the electromagnetic signal that carried the message, the return signal strength indication (RSSI). For example, when the active RFID tag is very close to the reading antenna, the RSSI may be a very high (e.g., a RSSI value of 100 in a range of RSSI between 0 and 100), and when the active RFID tag is at the far reaches of the usable range, the RSSI may be very low (e.g., a RSSI value of 1 in a range of RSSI between 0 and 100).

Semi-active and passive RFID tags, unlike active RFID tags, transmit based on backscattered electromagnetic signals, When the semi-active and/or passive RFID tag is very close to the reading antenna, the difference in backscattered signal strength as between when the antenna of the RFID tag is absorbing power, and when the RFID tag is reflecting power, may be very high. Conversely, when the semi-active and/or passive RFID tag is far from the reading antenna 18, the difference in backscattered signal strength as between when the antenna of the RFID tag is absorbing power and when the RFID tag is reflecting power may be very low, and yet the reader circuit 12 may still be able to extract the message and corresponding value of interest. Here too, the RFID reader 12 generates a RSSI indicative of the signal strength of the electromagnetic signal. In the case of RSSI for semi-active and/or passive tags, the RSSI may be an indication of the ratio of the peak reflected signal strength (i.e., RFID tag reflecting power) to the background signal strength (i.e., RFID tag absorbing power). In other embodiments, the RSSI for semi-active and/or passive tags may be the ratio of a maximum possible reflected power (i.e., signal strength with RFID tag close to the phased-array antenna and the RFID tag reflection) to the actual reflected power. As an example of possible RSSI, when the passive RFID tag is very close to the reading antenna, the RSSI may be very high (e.g., a RSSI value of 100 in a range of RSSI between 0 and 100), and when the RFID tag is at the far reaches of the usable range, the RSSI may be very low (e.g., a RSSI value of 1 in a range of RSSI between 0 and 100).

Regardless of the active or passive construction of the RFID tag used, in accordance with some embodiments a value indicative of the distance from the phased-array antenna to the RFID tag is made based on RSSI. For example, prior to actual use, a system (such as in FIG. 1) may be calibrated by placing a RFID at several measured or otherwise known distances from the phased-array antenna 14. Based on the RSSI for the several known distances, RSSI values may be correlated to actual distance. Thus, when electronic system 10 receives an RSSI value from the RFID reader 12, the electronic system 10 may determine a value indicative of the distance to the RFID tag based on the RSSI. Moreover, given that the location system 13 determines a direction or orientation of the RFID tag to the phased-array antenna 14, the electronic system 10 may thus determine a location of any particular RFID tag.

In accordance with the various embodiments, the system 1000 of FIG. 1 may determine direction, and in some embodiments distance, in systems using RFID tags that were not designed originally to be used for location determinations. For example, RFID tags operated under the RFID Air Interface Protocol, promulgated by EPCglobal, Inc., are not concerned with location determinations; however, in some embodiments the period of time that an RFID tag transmits under the RFID Air Interface protocol is sufficient for location/distance determination in accordance with the various embodiments. In other cases, however, the period of time that a RFID tag may transmit under a particular protocol may be insufficient for a location/direction determination. In order to assist, in accordance with at least some embodiments, the RFID reader 12 is configured to send, and the RFID tags 16 are configured to receive and act in response to, a “Repeat” command. When the RFID reader 12, location system 13 and/or electronic system 10 needs a particular RFID tag to transmit on a continuous basis (e.g., in an attempt more accurately determine the location of the RFID tag), the RFID reader sends the “Repeat” command to the RFID tag. The RFID tag, in turn, repeatedly transmits data to The RFID reader, Co-pending and commonly assigned application Ser. No. 11/746,244 titled “Method and System of Placing a RFID Tag in a Continuous Transmission Mode,” which is incorporated by reference herein as if reproduced in full below, describes RFID tags having the ability to enter a repeating transmission mode.

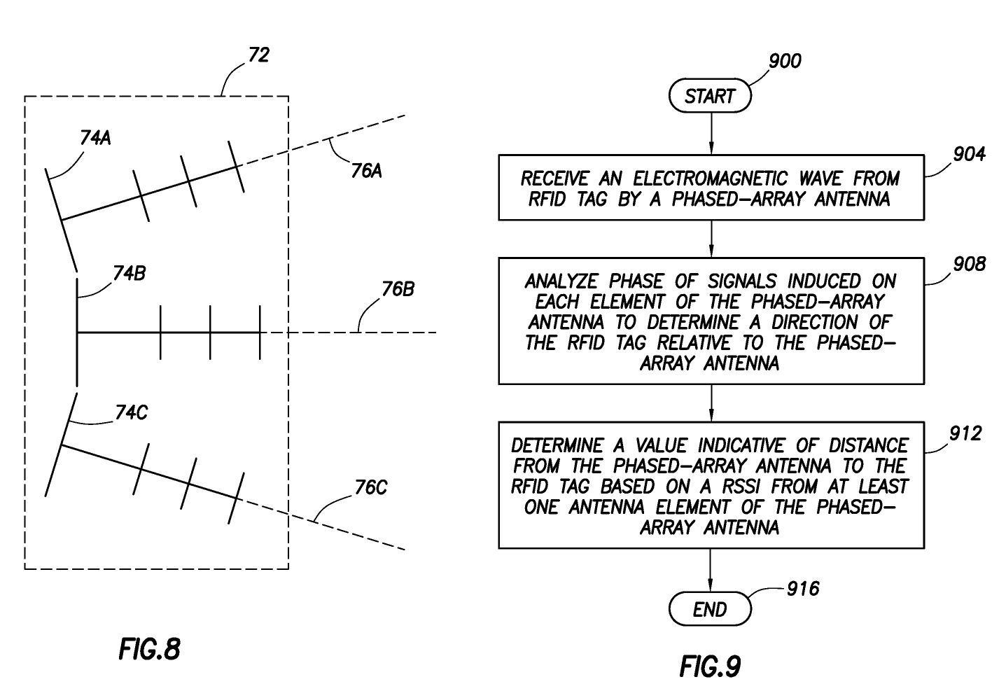

FIG. 9 illustrates a method in accordance with at least some embodiments. In particular, the method starts (block 900) and proceeds to receiving an electromagnetic signal from RFID tag by a phased-array antenna (block 904). The receiving may take many forms. In some embodiments, the receiving is by way of a one dimensional phased-array antenna. In yet other embodiments, the receiving is by way of a two dimensional phased-array antenna. Further, the receiving may be from a RFID tag responding to a query for the data payload of the RFID tag, or the RFID tag may be in a specific repeating transmission mode to lengthen the length of time the RFID tag transmits. Regardless of the precise nature of the receiving, after receiving an analysis of phase of signals induced on each element of the phased-array antenna is made to determine a direction of the RFID tag relative to the phased-array antenna (block 908). For example, for a plurality of phase delay values, the phase delay values may be applied (in integer multiples respectively) to the signals induced on each antenna element of the phase-array antenna to produce delayed signals. The delayed signals may be combined to produce a combined signal for each phase delay value, and characteristics of the combined signals analyzed to determine value indicative of direction of the RFID tag. In some embodiments the method may comprise determining a value indicative of distance from the phased-array antenna to the RFID tag based on a RSSI from at least one antenna element of the phased-array antenna (block 912), and the illustrative method ends (block 916).

The above discussion is meant to be illustrative of the principles and various embodiments of the present invention. Numerous variations and modifications will become apparent to those skilled in the art once the above disclosure is fully appreciated. For example, the analysis of phase to determine the direction of the RFID tag relative to the phased-array antenna may be alternatively thought of as mathematically steering the directionality of the phased-array antenna. It is intended that the following claims be interpreted to embrace all such variations and modifications.

What is claimed is:

1. A system comprising:
a radio frequency identification (RFID) reader; and
a phased-array reading antenna coupled to the RFID reader, the phased-array reading antenna comprising a plurality of antenna elements;
wherein the system is configured to determine a value indicative of direction of a RFID tag relative to the phased-array reading antenna based on an analysis of phase of signals induced on each of the antenna elements of the phased-array antenna by a return signal from the RFID tag.

2. The system according to claim 1 further comprising a location circuit, wherein the location system coupled to the phased-array antenna, wherein the location system is configured to determine the value indicative of direction of a RFID tag relative to the phased-array reading antenna.

3. The system according to claim 1 wherein the system is configured to determine a value indicative of distance from the phased-array reading antenna to the RFID tag based on a return signal strength indication (RSSI) of at least one of the signals induced on an antenna element.

4. The system according to claim 3 wherein the system is configured to determine the value indicative of distance based on RSSI of the signals induced on each of the antenna elements.

5. The system according to claim 1 further comprising:
wherein, for a plurality of phase delay values, the system is configured to apply an integer multiple of the phase delay value to the signal induced on each of the antenna elements to produce delayed signals, and to combine the delayed signals to produce a combined signal;
wherein the system is configured to determine the value indicative of direction based on a characteristic of the combined signal.

6. The system according to claim 5 wherein the system is configured to determine the value indicative of direction based on at least one selected from the group consisting of: a phase delay value where an amplitude of the combined signal is substantially a minimum; and a phase delay value where an amplitude of the combined signal is substantially a maximum.

7. The system according to claim 5 wherein the system determines the value indicative of direction of the RFID tag by a lookup table that correlates phase delay values to direction of the RFID tag.

8. The system according to claim 1 wherein the phased-array antenna further comprises:
each antenna element having a reception pattern with a main lobe defining an axis;
wherein the axes are substantially parallel.

9. The system according to claim 8 wherein the axes are all co-planar.

10. The system according to claim 1 wherein the phased-array antenna further comprises:
each antenna element having a reception pattern with a main lobe defining an axis;
wherein the axes are non-parallel.

11. A method comprising:
receiving at a phased-array antenna an electromagnetic wave transmitted by a radio frequency identification (RFID) tag; and
analyzing phase of signals induced on each element of the phased-array antenna to determine a direction of the RFID tag relative to the phased-array antenna.

12. The method according to claim 11 wherein receiving further comprises receiving a backscattered electromagnetic wave from the RFID tag.

13. The method according to claim 11 wherein receiving further comprises receiving the electromagnetic wave generated from power provided by a battery of the RFID tag.

14. The method according to claim 11 further comprising determining a value indicative of distance from the phased-array antenna to the RFID tag based on a return signal strength indication (RSSI) from at least one antenna element of the phased-array antenna.

15. The method according to claim 11 wherein analyzing phase further comprises:
for a plurality of phase delay values:
applying an integer multiple of the phase delay value to the signal induced on each of the antenna elements to produce delayed signals; and
combining the delayed signals to produce a combined signal for each phase delay value;
analyzing characteristics of the combined signals to determine the direction of the RFID tag.

16. The method according to claim 15 wherein analyzing further comprising determining a phase delay value indicative of direction based on amplitude of the combined signal.

17. The method according to claim 11 wherein receiving the electromagnetic wave further comprises receiving by way of a one-dimensional phased-array antenna.

18. The method according to claim 11 wherein receiving the electromagnetic wave further comprises receiving by way of a two-dimensional phased-array antenna.

19. A system comprising:
a means for receiving an electromagnetic wave transmitted by a radio frequency identification (RFID) tag and producing a plurality of electrical signals based on the electromagnetic wave;
a means for analyzing the plurality of signals to determine a direction of the RFID tag relative to the means for receiving.

20. The system according to claim 19 further comprising a means for determining a value indicative of distance from the RFID tag to the means for receiving.

21. The system according to claim 19 wherein the means for analyzing further comprises:
a means for selectively phase delaying each of the plurality of electrical signals to create a plurality of delayed signals;
a means for combining the plurality of delayed signals to created a combined signal; and
a means for comparing a plurality of combined signals.
